(19) United States
(12) Patent Application Publication
(10) Pub. No.: US 2012/0220221 A1
(43) Pub. Date: Aug. 30, 2012

(54) COMMUNICATION SYSTEM PROVIDING DATA TRANSFER DIRECTION DETERMINATION BASED UPON ORIENTATION AND RELATED METHODS

(75) Inventors: VAHID MOOSAVI, Kitchener (CA); DAVID RYAN WALKER, Waterloo (CA); KEVIN ORR, Elmira (CA)

(73) Assignees: Ontario, Canada), Waterloo (CA); Research In Motion Limited (a corporation organized under the laws of the Province of

(21) Appl. No.: 13/034,006

(22) Filed: Feb. 24, 2011

(51) Int. Cl. H04B 5/00

(52) U.S. Cl. 455/41.1

(57) ABSTRACT

A communication system may include at least one electronic device configured to wirelessly communicate via a Near-Field Communication (NFC) format, and at least one mobile communications device. The at least one mobile communications device may include an NFC device configured to wirelessly communicate with the at least one electronic device via the NFC format, and a controller coupled with the NFC device. The controller may be configured to determine an orientation of the at least mobile communications device, and determine a direction of communication with respect to the at least one electronic device based upon the determined orientation.

### TECHNICAL FIELD

This application relates generally to the field of communications, and more particularly, to electronic devices and related methods that use near-field communication (NFC).

### BACKGROUND

Mobile communication systems continue to grow in popularity and have become an integral part of both personal and business communications. Various mobile devices now incorporate Personal Digital Assistant (PDA) features such as calendars, address books, task lists, calculators, memo and writing programs, media players, games, etc. These multi-function devices usually allow electronic mail (email) messages to be sent and received wirelessly, as well as access the Internet via a cellular network and/or a wireless local area network (WLAN), for example.

Some mobile devices incorporate contactless card technology and/or near field communication (NFC) chips. NFC technology is commonly used for contactless short-range communications based on radio frequency identification (RFID) standards, using magnetic field induction to enable communication between electronic devices, including mobile wireless communications devices. This short-range high frequency wireless communications technology exchanges data between devices over a short distance, such as only a few centimeters.

### BRIEF DESCRIPTION OF THE DRAWINGS

FIG. 1 is a schematic block diagram of a communication system in accordance with one example aspect.

FIG. 2 is schematic block diagram of an alternative embodiment of the system of FIG. 1.

FIGS. 3 and 4 are flow diagrams illustrating method aspects associated with the systems of FIGS. 1 and 2.

FIGS. 5 through 8 are front elevational views of example mobile wireless communications devices of the system of FIG. 2 illustrating various use cases.

FIG. 9 is a schematic block diagram illustrating example components that may be used with the mobile wireless communications devices of FIGS. 1, 2 and 5-8.

FIG. 10 is a side view of the mobile wireless communications devices shown in FIGS. 5 and 6.

### DETAILED DESCRIPTION

The present description is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in alternative embodiments.

Generally, a communication system is disclosed herein which may include at least one electronic device configured to wirelessly communicate via a Near-Field Communication (NFC) format, and at least one mobile communications device. The mobile communications device may include an NFC device configured to wirelessly communicate with the at least one electronic device via the NFC format, and a controller coupled with the NFC device. The controller may be configured to determine an orientation of the at least one mobile communications device, and determine a direction of communication with respect to the at least one electronic device based upon the determined orientation. As such, the orientation of the mobile communications device may advantageously be used to determine whether transmitting data (e.g., digital content data) to, receiving data from, or exchanging data with, the electronic device is appropriate.

More particularly, the at least one mobile communications device may further comprise an orientation detection sensor coupled with the controller, and the controller may be further configured to determine the orientation of the at least one mobile communications device based upon the orientation detection sensor. The orientation detection sensor may comprise an accelerometer, an optical sensor, a gyroscope and/or a magnetometer. The controller may also be configured to cause the NFC device to transmit and/or receive digital content data to the at least one electronic device based upon determined orientation of the at least one mobile communications device.

The at least one mobile communications device may further comprise a housing carrying the NFC device and the controller, and a display carried by the housing. The controller may be configured to cause the NFC device to transmit digital content data to the at least one electronic device when the determined orientation of the at least one mobile communications device includes the display facing substantially upward, for example. The controller may be configured to cause the NFC device to receive digital content data from the at least one electronic device when the determined orientation of the at least one mobile communications device includes the display facing substantially downward, for example.

The controller may be further configured to determine an impact to the housing, and to cause the NFC device to exchange digital content data with the at least one electronic device based upon the determined impact to the housing. The at least one electronic device may be further configured to determine an orientation thereof, and the at least one electronic device and the controller are configured to exchange digital content data therebetween based upon the respective determined orientations. The controller may be further configured to determine the orientation of the mobile communications device and the direction of communication prior to establishing NFC communications with the at least one electronic device.

Also, the mobile communications device may further comprise a wireless transceiver carried by the housing, with the wireless transceiver being configured to communicate via a wireless communications network.

A related mobile communications device, such as the one described briefly above, and a related communication method are also provided. The method may include determining an orientation of the at least one mobile communications device, and determining a direction of communication with respect to the at least one electronic device based upon the determined orientation.

A non-transitory computer-readable medium for a mobile communications device, such as the one described briefly above, is also provided. The non-transitory computer-readable medium may have computer executable instructions for causing the mobile communications device to perform steps comprising determining an orientation of the at least one mobile communications device, and determining a direction of communication with respect to the at least one electronic device based upon the determined orientation.

By way of background, mobile communications devices (also referred to as “mobile devices” herein), such as portable cellular telephones, etc. are being equipped with short-range communications capabilities (e.g., NFC) to enable near field communication of information or data between mobile devices as well as other electronic devices (e.g., NFC tags, etc.). Data such as digital content data (e.g., electronic files, etc.) stored in the memory of one mobile device may be transmitted to another mobile device (or other electronic device, etc.) via NFC communications, or such data may be exchanged between the devices.

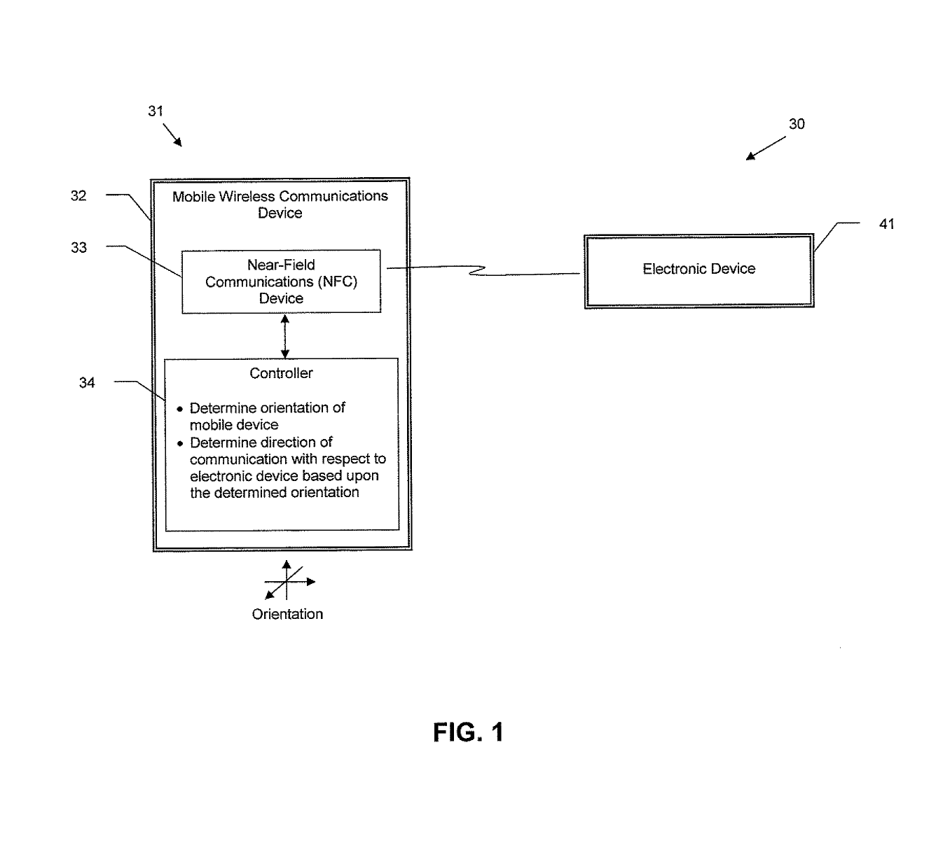

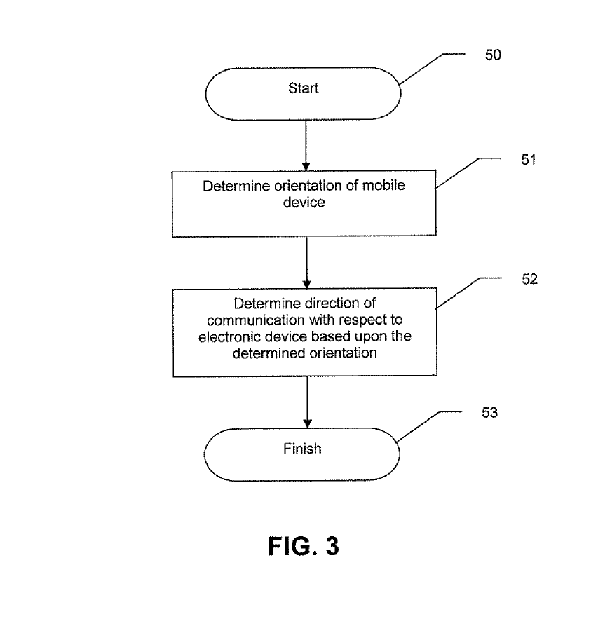

Referring initially to FIGS. 1 and 3, a communication system 30 illustratively includes an electronic device 41 which is configured to communicate via a short-range communications format (e.g., NFC). The system 30 further illustratively includes a mobile device 31 which includes a portable housing 32, a NFC device 33 carried by the portable housing 32 and configured to communicate via the NFC format, and a controller 34 carried by the portable housing 32 and coupled to the NFC device 33.

NFC is a short-range wireless communications technology in which NFC-enabled devices are “swiped,” “bumped” or otherwise moved in close proximity to communicate. In one non-limiting example implementation, NFC may operate at 13.56 MHz and with an effective range of about 10 cm, but other suitable versions of near-field communication which may have different operating frequencies, effective ranges, etc., for example, may also be used.

By way of example, various mobile devices that may be used for the embodiments described herein include portable or personal media players (e.g., MP3 players, video players, etc.), remote controls (e.g., television or stereo remotes, etc.), portable gaming devices, portable or mobile telephones, smartphones, tablet computers, etc. Furthermore, the controller 34 may be implemented using a combination of hardware (e.g., microprocessor, etc.) and non-transitory computer-readable medium components having computer-executable instructions for performing the various operations described herein. Moreover, the electronic device 41 may also be a mobile device, although it may be stationary or otherwise intended not to be readily portable, such as a television, stereo, desktop computer, etc. In some embodiments, the electronic device may comprise an NFC tag (e.g., a poster tag, etc.), for example.

Referring also to the flowchart in FIG. 3, beginning at Block 50, the controller 34 may be configured to communicate with the electronic device 41 via the NFC device 33 when in proximity therewith. The controller 34 is further configured to determine an orientation of the mobile device 31, at Block 51, and to determine a direction of communication with respect to the electronic device 41 based upon the determined orientation, at Block 52, which concludes the method illustrated in FIG. 3 (Block 53). As such, it may advantageously be determined if the mobile device 31 is attempting to transmit data (e.g., digital content data) to the electronic device 41, receive data therefrom, or both (i.e., to exchange data therewith). In other words, by “direction of communication” it is meant which way digital content data is “flowing”, i.e., from the mobile device 31 to the electronic device 41, from the electronic device 41 to the mobile device 31, or both. In certain embodiments, the controller 34 is further configured to determine the orientation and the direction of communication prior to establishing NFC communications with the at least one electronic device 41. This may be advantageous to avoid conflicts during the NFC negotiations between devices, e.g. in establishing transmission and reception modes.

By way of example, the digital content data may include contacts (e.g., digital business cards), audio, video, images, addresses or appointments, documents, applications, financial information, security information, etc.

In the present example, the mobile device 31 may have an upward orientation relative to the electronic device 41 which is stationary. As such, the controller 34 determines that it should be transmitting data to the electronic device 41 due to the orientation of the mobile device 31. On the other hand, if the controller 34 determines that the mobile device has a downward orientation as the portable housing 32 is being bumped with (i.e., impacted) the electronic device 41 or at the time when NFC communication otherwise commences due to close proximity, then the controller 34 determines that it is to receive digital content data from the electronic device 41. However, it should be noted that this order may be reversed in some embodiments.

In the above-described example, the mobile device 31 (the transmitting device) is oriented generally upward, and the mobile device 41 (the receiving device) is oriented generally downward with respect to the Z-axis. Using an accelerometer which includes Z-axis measurement, a positive reading, for example, of approximately +1 g, indicates the mobile device is pointing upward, while a negative reading, for example, of approximately −1 g, indicates the mobile device is upside down. In other embodiments, various orientations and/or pairs of orientations may be used in the determination of the direction of communication. For example, orientations including vertical, facing away or facing toward the device operator, top up or top down etc. may be contemplated. By way of example, one device may be substantially vertical with is display facing user A, while the other device is substantially horizontal, with its display facing up so that user B can still see the display. In another example embodiment, one device may be in a portrait orientation (with its display facing user A), while the other device is in a landscape orientation (with its display facing user B). In accordance with another example embodiment, one device may be substantially vertical with its display facing user A, while another device is substantially vertical with its display facing user B, but upside down. It should also be noted that in some embodiments, more than two devices may be used.

Pre-selection of data qualified to transmit via NFC communications may be a precondition of data exchange in some embodiments. For example, a business card (e.g., a personal address book contact) for the mobile device 31 owner may be pre-selected as enabled for communication via NFC, while the remainder of the address book would not be pre-selected or designated for communication. In this way, the business card may be a “default” file that is automatically transferred to a different mobile device upon movement of a given mobile device to initiate NFC communications.

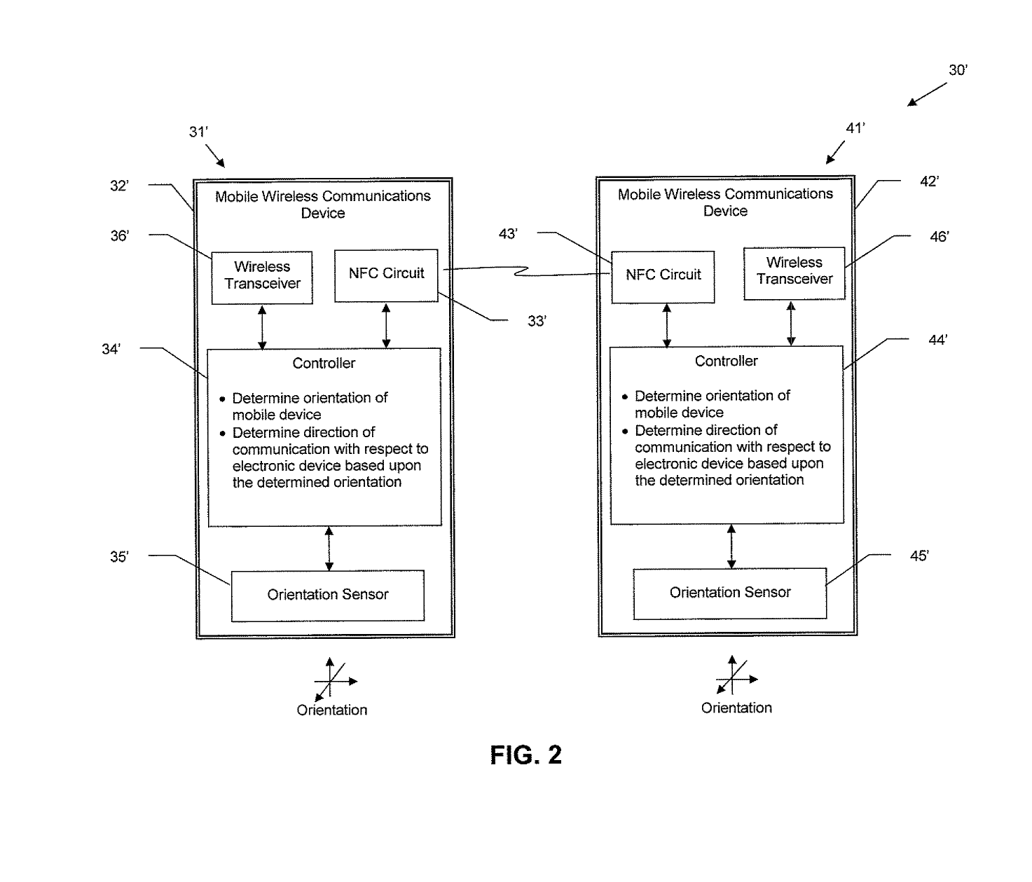

Referring additionally to FIG. 2, in this example the electronic device 41′ is also a mobile device similar to the mobile device 31′. Here both of the mobile devices 31′, 41′ have NFC circuits 33′, 43′ and further include an orientation sensor 35′, 45′ (such as an accelerometer) carried by their portable housings 32′, 42′ and coupled to their controllers 34′, 44′, respectively. As such, the controllers 34′, 44′ may advantageously use the accelerometers 35′, 45′ to determine the respective orientation of the mobile devices 31′, 41′.

It should be noted that in some embodiments the orientation of a mobile device may be determined or detected by a component other than an accelerometer. For example, this may be done based upon movement detected from an optical sensor (e.g., a charge-coupled device (CCD)), gyroscope, magnetometer/compass, etc.

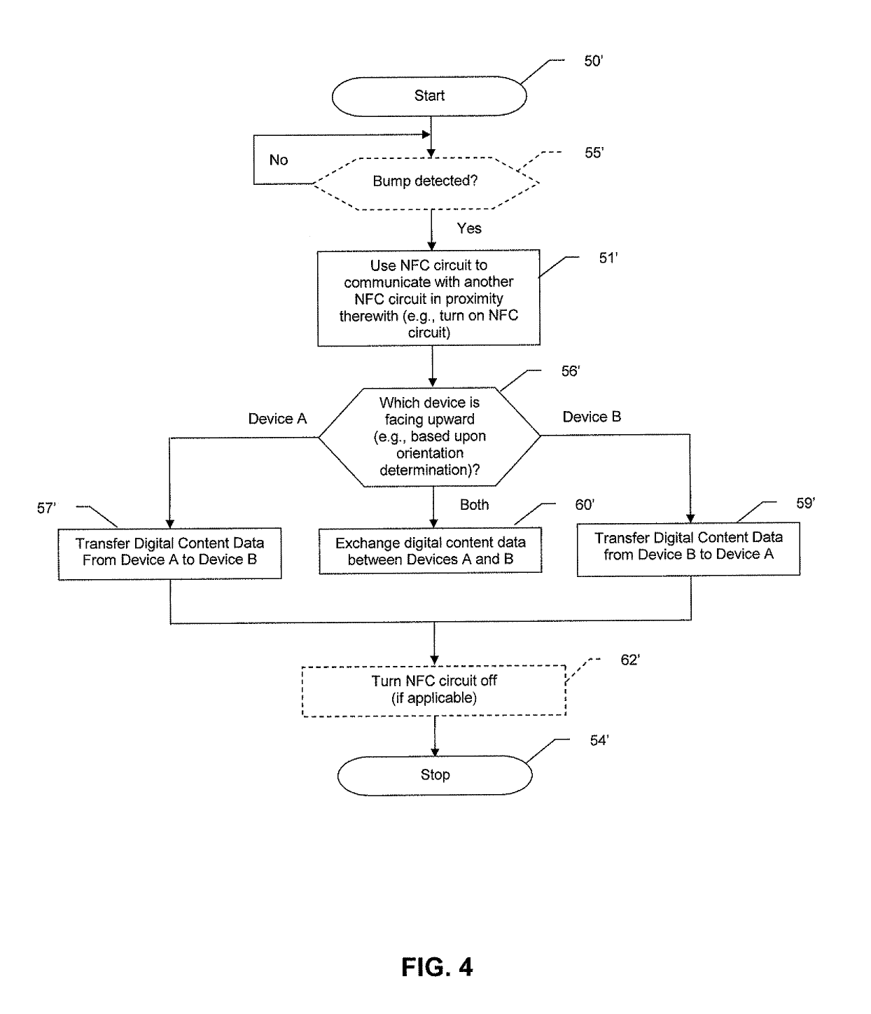

Referring additionally to the flowchart of FIG. 4, upon detection of the bump, at Block 55′, the NFC circuits 33′, 43′ may begin communicating (e.g., they may be turned on or otherwise enabled for communication), at Block 51′, and the controllers 34′, 44′ may advantageously determine whether their respective mobile devices 31′, 41′ are facing upward, for example, at the time of the bump, at Block 56′. In the case where the NFC circuits 33′, 43′ are powered on or awakened from a sleep mode by the physical contact of the mobile devices 31′, 41′, then these circuits may optionally be turned off or returned to a power-saving or sleep mode once NFC communications are complete, at Block 62′.

It should be noted, however, that a bump or physical contact of the mobile devices 31′, 41′ is not required in all embodiments. That is, the mobile devices 31′, 41′ need not actually physically contact in all embodiments for NFC (or other short-range) communications to take place. As such, the triggering event for when to check for movement may be when NFC communications are first initiated (i.e., the NFC circuits 33′, 43′ first come in range and begin communicating with one another), for example. For instance, one or both of the NFC circuits 33′, 43′ may be operating in an active NFC mode and powered on prior to coming in proximity with each other, which will result in the detection of one another and commencement of NFC communication.

In the case wherein the mobile device 31′ has an upward orientation prior to the bump but the mobile device 41′ does not, the controller 34′ conveys its digital content data to the controller 44′ via the NFC circuit 33′, 43′, at Blocks 56′, 57′. In the reverse case, i.e., wherein the mobile device 31′ does not have an upward orientation prior to the bump but the mobile device 41′ does, then the controller 44′ conveys its digital content data to the controller 34′ via the NFC circuits 33′, 43′, at Block 59′.

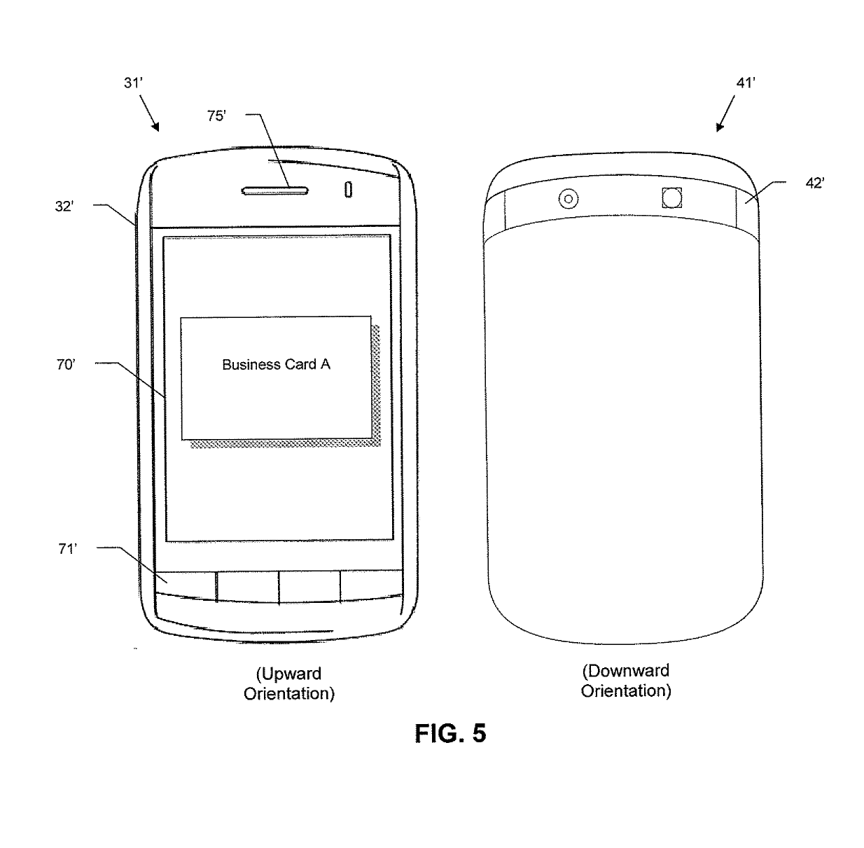

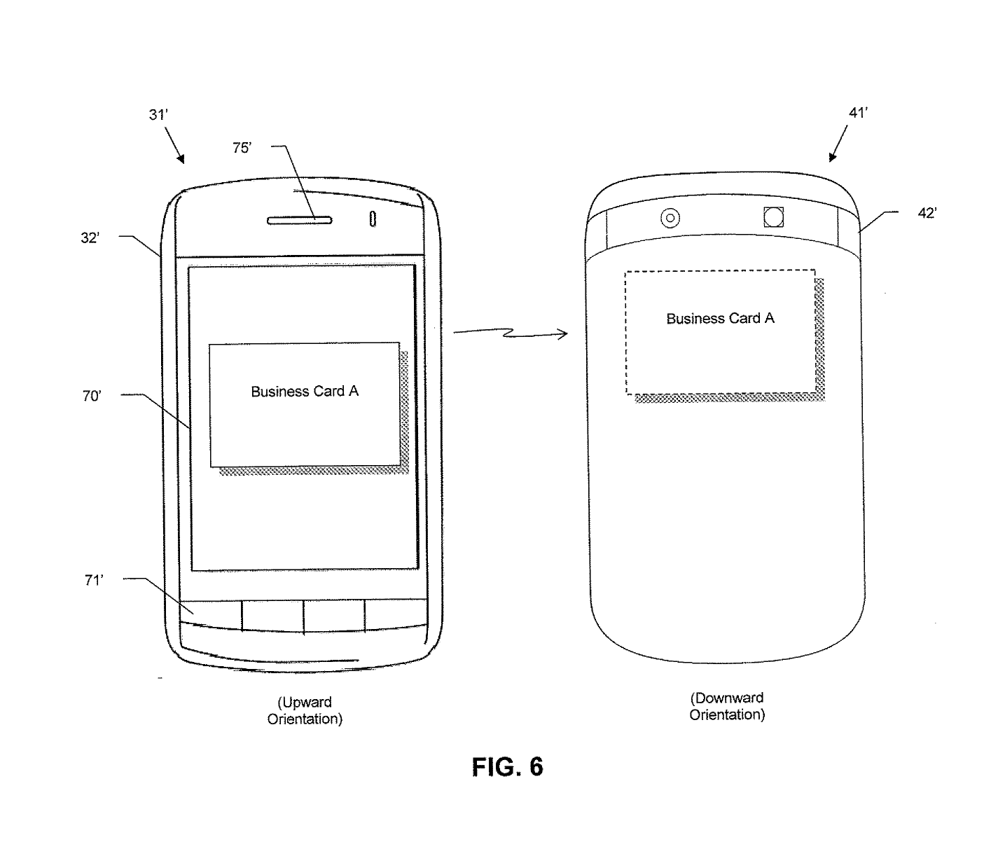

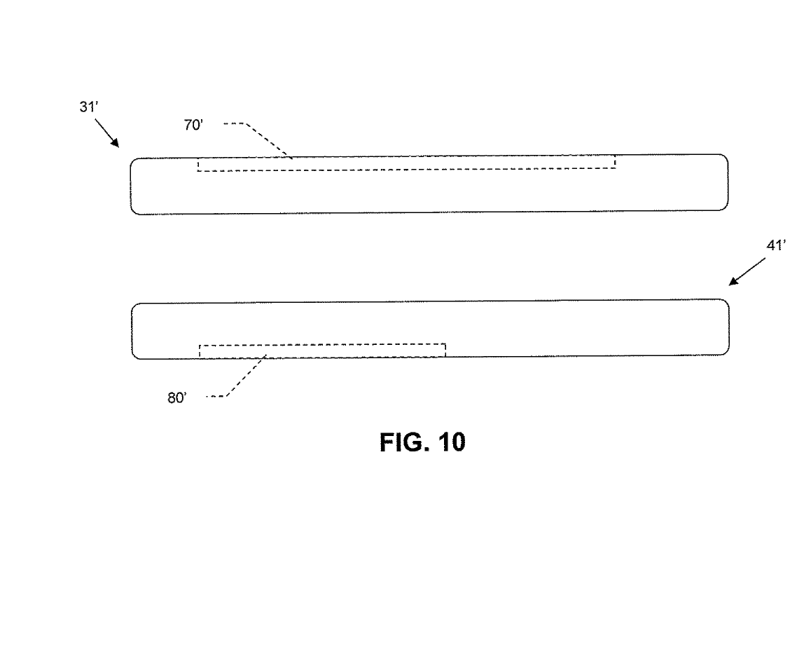

By way of example, in FIG. 5 the mobile device 31′ is schematically illustrated as facing upwardly relative to a mobile device 41′ (see also FIG. 10). In this example embodiment, the mobile device 31′ further includes a touch screen display 70′, input buttons 71′, and an audio output transducer 75′, all of which are carried by the housing 32′ and coupled to the controller 34′. Moreover, the mobile device 41′ illustratively includes a display 80′, a trackpad or track ball 82′ and a keypad 83′ (which serve as input devices), and an audio output transducer 85′, all of which are carried by the housing 42′ and coupled to the controller 44′. In the example of FIG. 5, the mobile device 31′ is initially displaying a contact “business card” (“Business Card A”) on the display 70′ prior to contact with the stationary mobile device 41′. That is, displaying a digital content item (e.g., contact, image, etc.) on the display may designate that item for transfer upon movement of the mobile device 31′ into contact with the mobile device 41′, although in other embodiments content may be pre-selected for transfer via other approaches, as discussed above. Once the bump occurs, the controller 34′ transmits the business card to the controller 44′, as seen in FIG. 6. This transfer may be accomplished by the NFC circuits 33′, 43′, or in some embodiments the transfer may be performed via a separate communications path, such as via the wireless transceivers 36′, 46′ (e.g., Bluetooth, etc.).

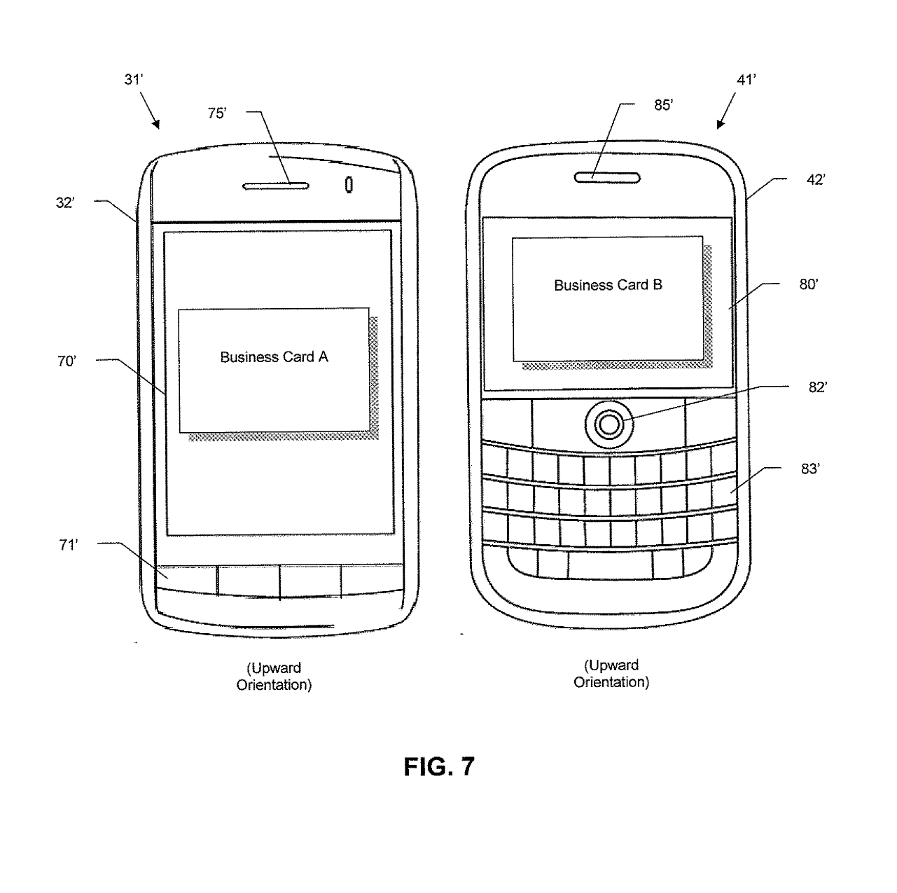

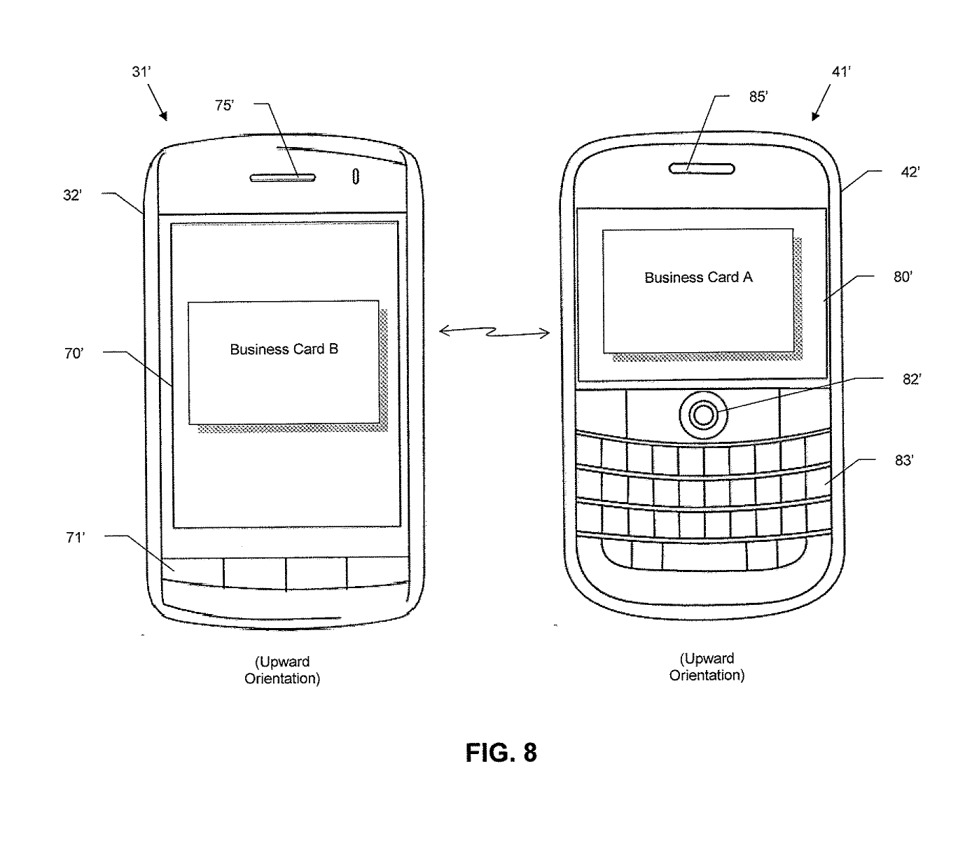

In the case where both mobile devices 31′, 41′ are facing upwardly just prior to the bump (i.e., they bumped each other), then the controllers 33′, 43′ exchange respective digital content data, at Block 60′. An example implementation of this case is shown in FIGS. 7 and 8. As seen in FIG. 7, each of the mobile devices 31′, 41′ is displaying a business card (“Business Card A”, “Business Card B”) on its respective display 70′, 80′ and are schematically illustrated as facing upwardly relative to one another. After the bump occurs, the digital business cards are exchanged between the mobile devices 31′, 41′, as seen in FIG. 8.

In the examples of FIGS. 5-8, both of the mobile devices 31′, 41′ have orientation detection capabilities (i.e., the orientation sensors 35′, 45′). However, referring again to FIG. 1, in some embodiments the electronic device 41 may be stationary or not have orientation detection capabilities. For example, the electronic device 41 may be a personal computer, etc., with NFC capabilities (e.g., an NFC peripheral) but no orientation detection capabilities. Yet, it may still be desirable to utilize the motion of the mobile device 31 to not only transmit digital content data to the electronic device 41, but also to receive digital content data therefrom (or exchange digital content data therewith). These different operations may be invoked by using only the detected orientation of the mobile device 31 to signify a respective data transfer operation.

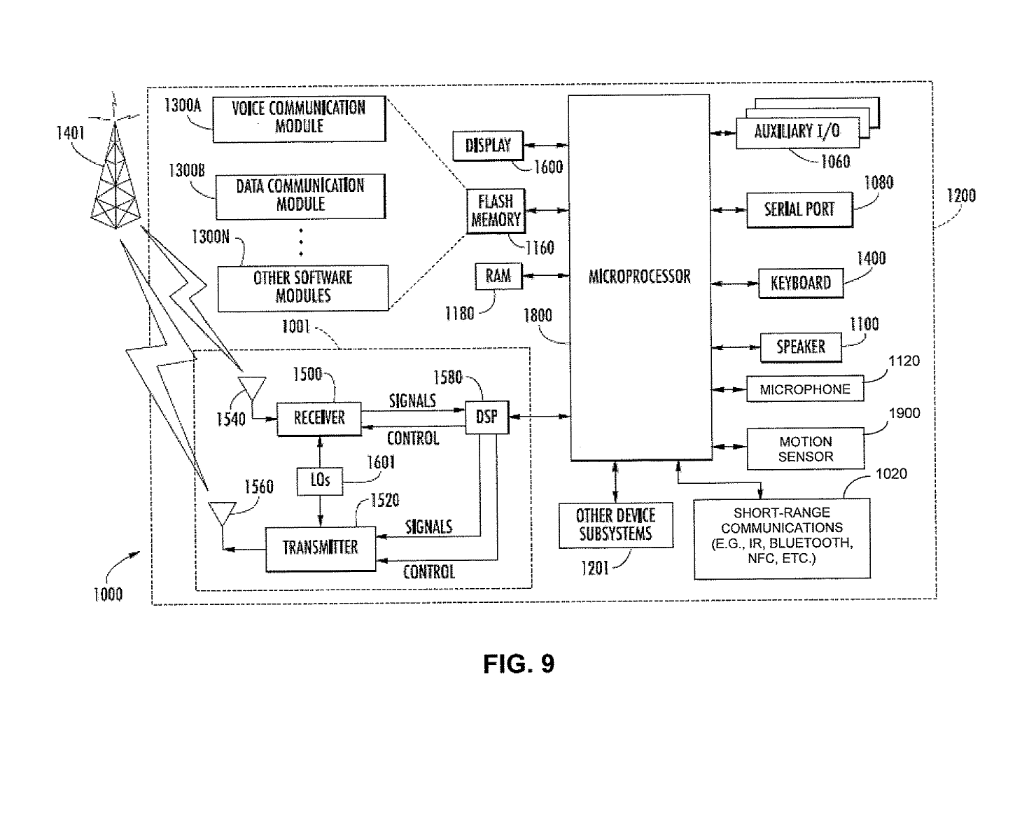

Example components of a mobile wireless communications device 1000 that may be used in accordance with the above-described embodiments are further described below with reference to FIG. 9. The device 1000 illustratively includes a housing 1200, a keyboard or keypad 1400 and an output device 1600. The output device shown is a display 1600, which may comprise a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 9. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOS) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3GPP, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore typically involves use of a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device may also be used to compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, a Bluetooth™ communications module to provide for communication with similarly-enabled systems and devices, or a near field communications (NFC) sensor for communicating with a NFC device or NFC tag via NFC communications.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A communication system comprising:
at least one electronic device configured to wirelessly communicate via a Near-Field Communications (NFC) format; and
at least one mobile communications device comprising
an NFC device configured to wirelessly communicate with said at least one electronic device via the NFC format, and
a controller coupled with said NFC device, the controller being configured to
determine an orientation of said at least one mobile communications device, and
determine a direction of communication with respect to said at least one electronic device based upon the determined orientation.

2. The communication system of claim 1 wherein said at least one mobile communications device further comprises an orientation detection sensor coupled with said controller; and wherein said controller is further configured to determine the orientation of said at least one mobile communications device based upon said orientation detection sensor.

3. The communication system of claim 2 wherein said orientation detection sensor comprises at least one of an accelerometer, an optical sensor, a gyroscope or a magnetometer.

4. The communication system of claim 1 wherein said controller is configured to cause said NFC device to transmit digital content data to said at least one electronic device based upon the determined orientation of said at least one mobile communications device.

5. The communication system of claim 1 wherein said at least one mobile communications device further comprises a housing carrying said NFC device and said controller, and a display carried by the housing; and wherein said controller is configured to cause said NFC device to transmit digital content data to said at least one electronic device when the determined orientation of said at least one mobile communications device includes the display facing substantially upward.

6. The communication system of claim 1 wherein said controller is configured to cause said NFC device to receive digital content data from said at least one electronic device based upon the determined orientation of said at least one mobile communications device.

7. The communication system of claim 1 wherein said at least one mobile communications device further comprises a housing carrying said NFC device and said controller, and a display carried by the housing; and wherein said controller is configured to cause said NFC device to receive digital content data from said at least one electronic device when the determined orientation of said at least one mobile communications device includes the display facing substantially downward.

8. The communication system of claim 1 wherein said at least one mobile communications device further comprises a housing carrying said NFC device and said controller; and wherein said controller is further configured to determine an impact to said housing, and to cause said NFC device to exchange digital content data with said at least one electronic device based upon the determined impact to said housing.

9. The communication system of claim 1 wherein said controller is further configured to determine the orientation of the mobile communications device and the direction of communication prior to establishing NFC communications with said at least one electronic device.

10. The communication system of claim 1 wherein said at least one electronic device is further configured to determine an orientation thereof; and wherein said at least one electronic device and said controller are configured to exchange digital content data therebetween based upon respective determined orientations.

11. The communication system of claim 1 wherein said mobile communications device further comprises a wireless transceiver carried by said housing, the wireless transceiver being configured to communicate via a wireless communications network.

12. A mobile communications device comprising:
a Near-Field Communication (NFC) device being configured to wirelessly communicate with at least one electronic device via an NFC format; and
a controller coupled with said NFC device, the controller being configured to
determine an orientation of the mobile communications device, and
determine a direction of communication with respect to the at least one electronic device based upon the determined orientation.

13. The mobile communications device of claim 12 further comprising an orientation detection sensor coupled with said controller; and wherein said controller is further configured to determine the orientation of said at least one mobile communications device based upon said orientation detection sensor.

14. The mobile communications device of claim 12 wherein said controller is configured to cause said NFC device to transmit digital content data to said at least one electronic device based upon a first determined orientation of said at least one mobile communications device, and to cause said NFC device to receive digital content data from said at least one electronic device based upon a second determined orientation of said at least one mobile communications device, the first determined orientation being different from the second determined orientation.

15. A communication method for at least one electronic device configured to wirelessly communicate via a Near-Field Communication (NFC) format, and at least one mobile communications device comprising an NFC device configured to wirelessly communicate with the at least one electronic device via the NFC format, the method comprising:
determining an orientation of the at least one mobile communications device; and
determining a direction of communication with respect to the at least one electronic device based upon the determined orientation.

16. The communication method of claim 15 wherein the at least one mobile communications device further comprises a controller coupled with the NFC device and an orientation detection sensor coupled with the controller; and wherein determining the orientation comprises using the controller to determine the orientation of the at least one mobile communications device based upon the orientation detection sensor.

17. The communication method of claim 15 further comprising transmitting digital content data from the at least one mobile communications device to the at least one electronic device based upon a first determined orientation of the at least one mobile communications device, and receiving digital content data at the at least one mobile communications device from the at least one electronic device based upon a second determined orientation of the at least one mobile communications device, the first determined orientation being different from the second determined orientation.

18. The communication method of claim 15 wherein the at least one mobile communications device further comprises a housing carrying the NFC communications device and the controller; and the method further comprising determining an impact to the housing, and wherein determining the direction of communication further comprises determining the direction of communication with respect to the at least one electronic device also based upon the determined impact to the housing.

19. A non-transitory computer-readable medium for a mobile communications device comprising a Near-Field Communication (NFC) device and configured to wirelessly communicate with at least one electronic device via an NFC communications format, the computer-readable medium having computer executable instructions for causing the mobile communications device to perform steps comprising:
determining an orientation of the at least one mobile communications device; and
determining a direction of communication with respect to the at least one electronic device based upon the determined orientation.

20. The non-transitory computer-readable medium of claim 19 wherein the mobile communications device further comprises an orientation detection sensor; and wherein determining the orientation further comprises determining the orientation of the mobile communications device based upon the orientation detection sensor.

21. The non-transitory computer-readable medium of claim 19 further having computer-executable instructions for causing the mobile communications device to perform steps comprising:
transmitting digital content data from the at least one mobile communications device to the at least one electronic device based upon a first determined orientation of the at least one mobile communications device; and
receiving digital content data at the at least one mobile communications device from the at least one electronic device based upon a second determined orientation of the at least one mobile communications device;
the first determined orientation being different from the second determined orientation.

22. The non-transitory computer-readable medium of claim 19 wherein the mobile communications device further comprises a housing carrying the NFC device; wherein the computer-readable medium further has computer-executable instructions for causing the mobile communications device to perform a step comprising determining an impact to the housing; and wherein determining the direction of communication further comprises determining the direction of communication with respect to the at least one electronic device also based upon the determined impact to the housing.
